(19) United States
(12) Patent Application Publication
(10) Pub. No.: US 2005/0132057 A1
(43) Pub. Date: Jun. 16, 2005

(54) System and method for consolidation of mail and messages

(76) Inventors: Mark Bresnan, Newtown, CT (US); Bernard E. Gracy JR., Southbury, CT (US); Joann Martin, Ridgefield, CT (US)

Correspondence Address: Pitney Bowes Inc.;Intellectual Property and Technology Law Dept., 35 Waterview Drive, P.O. Box 3000, Shelton, CT, 06484, US

(21) Appl. No.: 10/736,998

(22) Filed: Dec. 16, 2003

(51) Int. Cl. G06F 15/16

(52) U.S. Cl. 709/227

(57) ABSTRACT

A message processing system for preparing a large quantity of messages to be distributed to recipients. A first component is a consolidator module receiving data corresponding to the plurality of messages to be processed. The consolidator module is programmed to select individual message do be consolidated into a single message package based on predetermined criteria. Exemplary consolidation criteria may include messages to be delivered to the same mailing address, messages having proximal due dates, messages for which the sender and recipient have authorized consolidation, messages for which marketing content is compatible, and messages for which business considerations are compatible. In a further preferred embodiment, the consolidator module is coupled to a customer relationship management system. The customer relationship management system is preferably used to determining at least some of the consolidation criteria and for generating a template for consolidated message packages.

### TECHNICAL FIELD

The present invention relates to a system and method for optimizing efficiency in mail and message production equipment and systems by consolidation of messages. Mail and message production equipment and systems may include high volume printers, inserter machines, mail sorting machines, electronic presentment systems, and the like.

### BACKGROUND

Systems for mass producing mail pieces are well known in the art. Such systems are typically used by organizations such as banks, insurance companies and utility companies for producing a large volume of specific mailings like billing statements, or promotional offers.

In many respects the typical inserter system resembles a manufacturing assembly line. Sheets and other raw materials (other sheets, enclosures, and envelopes) enter the inserter system as inputs. Modules or workstations in the inserter system work cooperatively to process the sheets into a finished mail piece. The exact configuration of each inserter system depends upon the needs of each particular customer or installation.

Typically, inserter systems prepare mail pieces by gathering collations of documents on a conveyor. The collations are then transported on the conveyor to an insertion station where they are automatically stuffed into envelopes. After being stuffed with the collations, the envelopes are removed from the insertion station for further processing. Such further processing may include automated closing and sealing the envelope flap, weighing the envelope, applying postage to the envelope, and finally sorting and stacking the envelopes.

Each collation of documents processed by the inserter system typically includes a control document having coded control marks printed thereon. Scanners are located throughout the inserter system to sense documents and to allow control for processing of a particular mail piece. The coded marks may be bar codes, UPC code, or the like.

The inserter system control system is coupled to the inserter system's modular components. The control system stores data files identifying how individual mail pieces should be processed. These data files are typically linked to individual mail pieces by the coded marks included on the control documents. As a collation passes through the inserter system, the coded marks on the control document are scanned and the control system directs the modular components to assemble the mail piece as appropriate.

In preparing mailpieces for mass production, cost savings opportunities are important considerations. One such opportunity arises from discounts offered by the United States Postal Service (USPS) for pre-sorting sufficient quantities of mail by zip-code. Pre-sort equipment is available that will sort mail pieces into bins in order to meet the criteria needed to qualify for the discounts.

Another approach to achieving discounts occurs prior to printing of the documents. Using known software, the mail piece print data can be organized so that mail piece documents are printed in a sequence that is substantially in conformance with the discount criteria. Thus, additional mechanical sorting can be minimized.

Another technique for cost savings is called “householding.” Mailers may determine that more than one customer has the same mailing address. In order to save postage and processing costs, the mailer may choose to combine communications to different customers into one envelope, provided that the different customers have the same mailing address. Thus, if householding is desired, in the pre-print processing of document data, documents for the same-address customers can be flagged as belonging to the same mail piece, and adjustments are made so that the documents are all processed together and included in the same envelope.

### SUMMARY OF THE INVENTION

The present invention provides further enhancements for efficiency and cost savings in mass production of mail pieces. In accordance with a preferred embodiment, the invention comprises a message processing system for preparing a large quantity of messages to be distributed to recipients.

A first component of the system is a consolidator module. The consolidator module receives data corresponding to the plurality of messages to be processed. The consolidator module is programmed to select individual message do be consolidated into a single message package based on predetermined criteria. Exemplary consolidation criteria may include messages to be delivered to the same mailing address, messages having proximal due dates, messages for which the sender and recipient have authorized consolidation, messages for which marketing content is compatible, and messages for which business considerations are compatible.

In a further preferred embodiment, the consolidator module is coupled to a customer relationship management system. The customer relationship management system is preferably used to determining at least some of the consolidation criteria and for generating a template for consolidated message packages.

Further details are provided in the accompanying detailed description, figures and claims.

### SUMMARY OF THE FIGURES

FIG. 1 is an exemplary system diagram for an architecture using the present invention.

FIG. 2 depicts exemplary steps for implementing message consolidation.

FIG. 3 depicts exemplary steps for implementing message package 5 distribution.

### DETAILED DESCRIPTION

One problem addressed by the present invention is reducing the amount of redundant messages or message content intended for a recipient from a sender. By reducing redundant message content and by reducing the overall number of messages produced, substantial savings may be realized.

In a first embodiment, consolidator-distributor 1 is composed of a pair of system engines that consume a set of rules as inputs, providing the means to rebuild message packages and route them as outputs. The engines collaborate together as an integrated decision-support enabler, designed for accuracy and optimization of automated processes.

The consolidator engine 11 is responsible for re-architecting a set of messages or message packages into a more efficient message or message package based upon a set of rules. In some embodiments, the rules may center around aggregating documents of common format together into a single document (consolidation) or composing a document package comprised of multiple documents intended for the same address in the form of a mailpiece (house-holding).

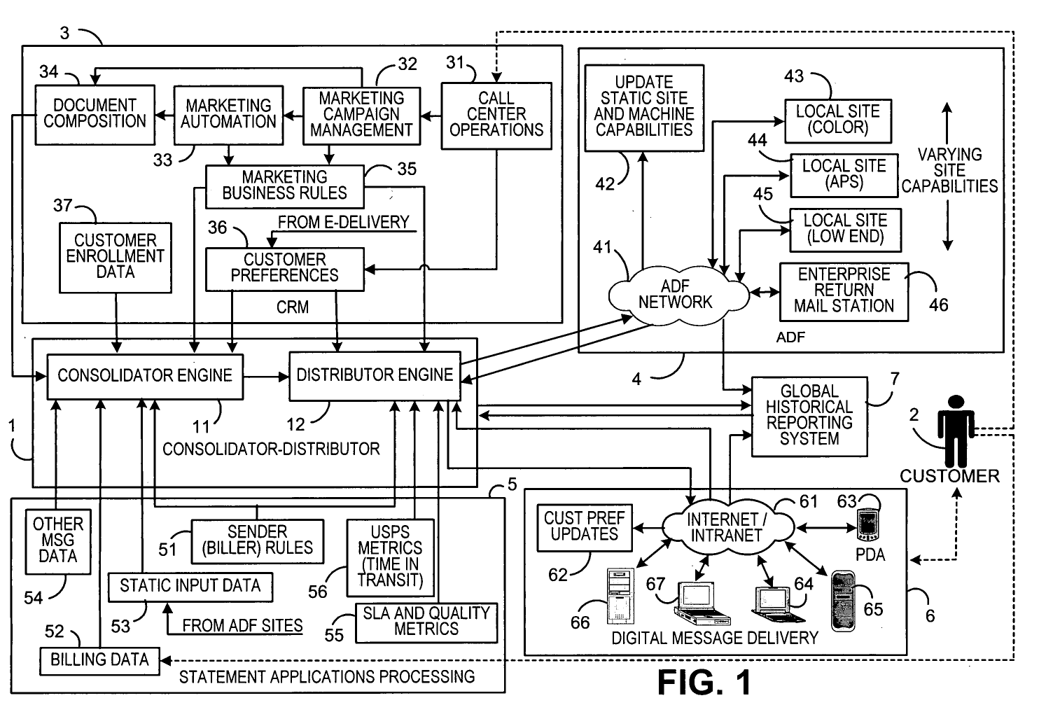

Referring to FIG. 1, the consolidator 11 portion of the consolidator-distributor 1 consolidates sets of business documents into a single document or document package by looking ahead in time and collecting a set of documents that qualify for consolidation. Criteria for consolidation may include (a) end user format preferences and pre-authorization, (b) sender preferences, (c) marketing campaign offers, and (d) due date cycle projections. The consolidator 11 may consolidate statements for several different accounts for the same destination address into a single statement or mail-piece.

The distributor 12 is responsible for applying a set of rules for determining the destination route and format of message outputs. As an example, the destination routes for a message or document might consist of a combination of production mail sites, electronic subsystems (including the Web), or a combination of both. The distributor engine 12 evaluates statement production requirements, contractual requirements, and delivery channel preferences to determine the routing of the statement data to an appropriate site for processing and induction into the mail stream (or electronic presentment). The distributor 12 is responsible for optimizing routing and format conversion of the document based on data available at the time of message generation.

Recipient preferences may indicate whether the recipient prefers hard-copy or electronic delivery. It is also expected that sender preferences will be biased towards minimizing time-in-transit, maximizing overall throughput, and/or minimizing materials and postage consumption. By working together the consolidator 11 and distributor 12 can optimize for the rules and preferences of both the sender and recipient.

Consolidator-distributor 1 may be used as an enterprise-messaging solution responsible for the aggregation and dissemination of intra-business, business to consumer, and business-to-business message packages originating within an enterprise. A “message package” is a package of content originating from a sender, intended for one or more recipients. A message package can have multiple layers of content, auxiliary content in the form of attachments, and multiple destinations. One example of a message package is a flat or folded mailpiece. Another example is an email message.

The consolidator-distributor 1 offers an enhanced messaging process as an adjunct to a closed loop message process. Accordingly, the present invention may be used advantageously in connection with a document production management and control system such as the one described in co-pending patent application Ser. No. 10/280,339, titled, DOCUMENT LIFECYCLE TRACKING SYSTEM AND METHOD FOR USE WITH A DOCUMENT PRODUCTION PROCESS, dated Oct. 25, 2002. This co-pending application is hereby expressly incorporated by reference.

In order to understand the functionality of the Consolidator-Distributor, the environment that it supports should be considered. An exemplary environment for the present invention is depicted in FIG. 1.

The systems architecture that describes the consolidator-distributor 1 includes the set of logical components responsible for creating, producing, enhancing, tracking, and managing an integrated, closed loop, message cycle. At the highest level the interacting processes consist of the Customer Relationship Management (CRM) 3 processes, the Automated Document Factory (ADF) 4 and Digital Document Delivery 6 processes, the Statement Applications Processing systems 5.

Consolidator-distributor 1 takes advantage of evaluating historical performance analytics (USPS, email, return mail, cash flows) to assist senders in reducing production costs, eliminating waste and increasing quality. At the same time, the consolidator-distributor 1 makes the message more attractive.

In a preferred embodiment, the application of the consolidator-distributor 1 may be suitable for periodic statement processing applications where iterative statement cycles can be improved and optimized over time. Direct mail applications could benefit as well by realizing the benefits of enhanced channel distribution for getting the message out.

Advantages that may be gained by the combination of the consolidator 11 and/or distributor 12 are as follows: minimizing production costs through consolidation (less paper, less inserts, less machine time, less operator time, less overall waste); minimizing USPS postage costs and maximizing efficiencies; maximizing end-customer satisfaction by adhering to preferences for message packaging; application of campaign offers and marketing messages once per document or document package through consolidation or house-holding; increasing customer satisfaction through elimination of producing redundant, unneeded, or unwanted messages; increasing customer satisfaction through the elimination of wasted time in consuming unwanted messages, paying bills, or viewing business correspondence for end-customers; increasing capital equipment savings by sharing capabilities of site configurations Increasing conformance to all SLA (service level agreement) requirements in an automated fashion; optimization of message routing, taking into account reduced time in transit, customer priority, and message value; automation of site selection based upon production capabilities; maximizing flexibility in responding to machine failures or disasters through automated message re-routing to alternate sites; maximizing end-customer satisfaction by adhering to channel preferences for message delivery; increasing adoption of e-delivery through seamless integration of processes and fulfillment of customer preferences; and enhancing quality control through applied metrics processes (6-sigma, ISO, etc).

A significant system that may be used in conjunction with the present invention is a customer relationship management system (CRM) 3. The purpose of CRM 3 is to assist in building customer relationships. Customer information acquired from sales, marketing, customer service, and support is captured and stored in a database. The system may provide data-mining facilities that support an opportunity management system. It may also be integrated with other systems such as statement applications processing 5 and an automated data factory (ADF) 4 for an enterprise-wide system.

A first component of CRM 3 is call center operations 31. Call center 31 is an important point of contact for a business to communicate with its customers 2, and may serve a number of different purposes. Call center 31 may be a point of contact for customers 2 to respond to a marketing campaign. In such case, customer marketing information is provided to the marketing campaign management system 32. Marketing campaign management system 32 may also be used to determine billboard messages to be included in final document template for communications. A customer 2 may also use the call center 31 to register for certain services and to express preferences in connection for future communications. Such preferences may be provided from the call center 31 to a customer preferences repository 36. Customer preferences 36 may include end user authorizations for consolidation of communications. Such preferences are provided to consolidator engine 11. Customer references 36 may also include distribution channel preferences to be provided to the distributor engine 12. Customer enrollment data 37 may also be captured and stored by other processes such as through mail communication, or the Internet. Customer enrollment data 37 may include name, address, and other customer information.

The marketing campaign management system 32 includes tools for analysis, planning, implementation, and control of programs designed to create, build, and maintain mutually beneficial exchanges with customers 2. Marketing campaign management system 32 may be coupled to marketing automation tools 33 and determines marketing business rules 35. An exemplary marketing business rule 35 may determine failover rules if a preferred method of distribution is not available. For example, if a color mail production site 43 was not available, a marketing rule might designate whether a non-color substitute was acceptable. Distribution related marketing rules are provided to the distributor 12, while consolidation related marketing rules are provided to the consolidator 11. Marketing automation tools 33 allow marketing executives to take advantage of current data to assist in determining marketing messages to be included as port of document composition 34.

With input from its various components CRM 3 determines the look, feel, and marketing content to be included on a communication document. When document composition 34 is complete, the document information is submitted to the consolidator-distributor module 1. Such document information is typically a form, or a virtual document template.

For the business content of a communication, the consolidator-distributor module 1 receives information from a statement applications processing module 5. Statements might typically include billing statements to be sent to customers. Statement applications processing 5 may include billing data 52, static input data 53, or other message data 54 (such as non-marketing based offers) that would typically be provided to the consolidator engine 11 of the consolidator-distributor module 1. Billing data 52 typically includes periodic accounting data, cycle information, due dates, and balances. Static input data 53 may include site capabilities, machine capabilities, and site territorial coverage, based on information received from ADF 4.

This module 5 may also provide USPS metrics 56 and SLA and quality metrics 55 to the distributor engine 12. USPS metrics 56 may include statistics on delivery times between different locations in the service area. SLA and quality metrics 55 may include particular requirements indentified as part of a service level agreement in order to provide satisfactory quality and reliability for a particular job. Finally, the statement application processing 5 generates and stores rules 51 identifying requirements of the biller for composition and delivery of the communication documents. Rules 51 include consolidation eligibility and rules about combinations of different communications to be provided to consolidator 11. Biller rules 51 may also include rules for minimizing costs, or optimization rules to be provided to the distributor 12.

As seen in FIG. 1, the consolidator-distributor 1 receives the information for the content of the communications from CRM 3 and statement processing module 5. The manner of production of the communication is handled by the consolidator-distributor 1, as will be discussed further below. The delivery and production of the documents is handled by an automated document factor (ADF) 4. Alternatively, or concurrently, the communication may be transmitted via a digital message delivery system 6.

Within the ADF 4, a network 41 controls communication between the devices for creating mail pieces. Network 41 also receives print stream data from the distributor 12. Network 41 also preferrably provides real time production data, machine status, production analytics, site status, and capacity information gathered from production sites 43-45.

ADF 4 may include mail production equipment at different sites and having different capabilities. For example, site 43 may be equipped to handle color documents, site 44 may be equippped with high-speed, hight volume equipment, such as a Pitney Bowes APS™ inserter machine, and site 45 may have less expensive lower-speed, lower volume equipment. An enterprise return mail station 46 monitors incoming mail. Such a return mail station 46 may typically associate incoming mail communications with a particular outgoing communication that was previously sent. The mail production machine status and capabilites 42 are stored and provided to the ADF network 41, so that the most up-to-date information is available for deciding which site to utilize for a given mail production job.

If documents are to be presented electronically, information is transmitted via a network 61, such as the Internet, or an intranet. Preferrably, such information is transmitted in an HTTP format to a variety of devices 63-67. The various devices 63-67 may receive communications in different electronic formats. For example, an e-delivery message may be sent in HTML format, an email communication may be sent via FTP or SMTP format, a message may be sent in XML format, a statement may be presented on a web services web site, or a bill may be presented on a portable wireless device. Customer preference updates 62 may further be transmitted back through network 61 to the consolidator-distributor module 1.

A global historical reporting system 7 receives data for tracking communications as they are processed through the various components described above. Reports may be generated detailing processing of a particular document, or the operation of a particular machine, or system. Historical metrics are provided from reporting system 7 to the consolidator-distributor 1. Audit data is provided from the consolidator-distributor 1 to the historical reporting system. Historical data is also collected from ADF 4, including mail piece tracking information from the return mail station 46, and from digital message delivery system 6.

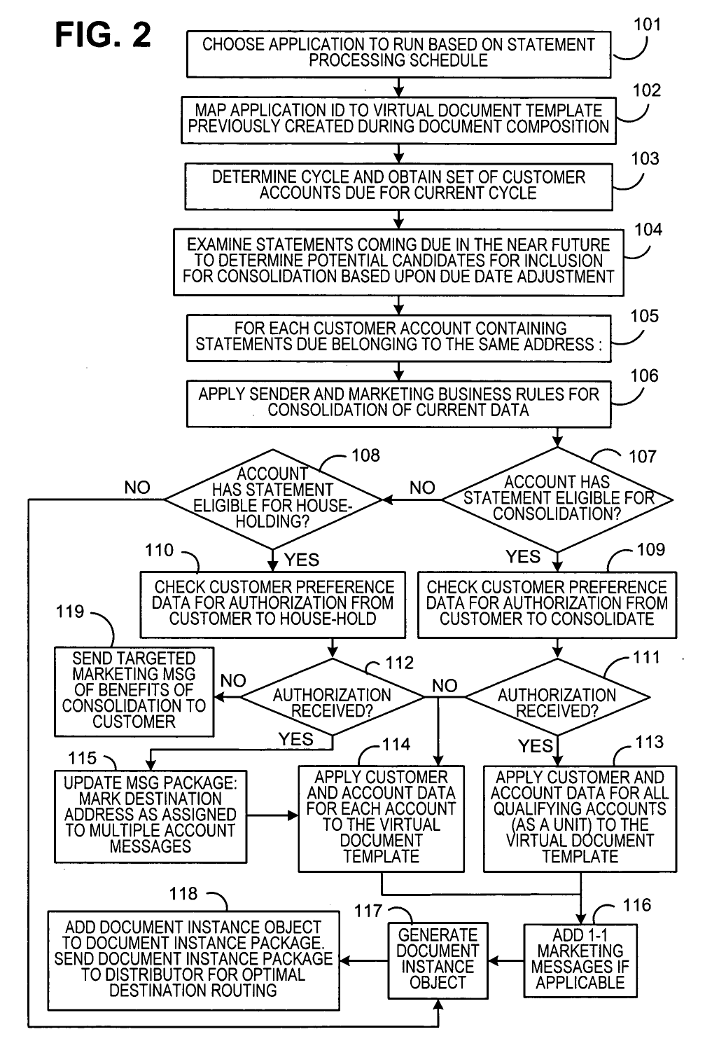

An exemplary flow-diagram of the operation of the consolidator engine 11 is depicted in FIG. 2. In a first exemplary step 101, the consolidator 11 chooses which business application to run. Typically business applications may be defined along different lines of business. For example, a large bank might have credit card accounts, mortgage accounts, and other financial services for which statements and other communications need to be periodiclly transmitted. In one embodiment each line of business might require separate processing. However, in an alternative embodiment, the consolidator 11 may concurrently process accounts for different lines of business in the same application. In a preferred embodiment, the application for processing is selected based on a predetermined schedule, and each application preferrably is assigned a unique identification number.

In a preferred embodiment, consolidation may involve combining communications for multiple accounts for the same individual. The multiple accounts may be in the same line of business, or across multiple lines of business. In a further enhanced embodiment, statements for different individuals with the same mailing address may be combined in accordance with householding rules.

In step 102, the appropriate template generated by the document composition tools 34 is selected for the particular application. The consolidator 11 determines the current timing in the transactional cycle, and selectes customer accounts pertinent for that cycle (step 103). In a first embodiment, the consolidator 11 determines potential candidates for consolidation based on the proximity of due dates. In order to facilitate consolidation, due dates for different transactions may be adjusted in order that the timing of the corresponding transactions not be altered. In a second embodiment, due dates are not adjusted, but candidates for for consolidation must have due dates within a predetermined time window. An exemplary time window would be within five days of each other.

At step 105, customer accounts having the same mailing address are identified. Next, the sender and marketing business rules for consolidation are applied to the previously identified statements (step 106). The busines rules for consolidation are determined based on the sender's perceived needs in connection with the particular communication. Certain types of information (such as health care information) may be determined to be too sensitive, and not appropriate for consolidation. From a marketing perspective, it may be determined that concurrent presentation of two transactions is more likely to result in an adverse decision by the customer, and therefore also not appropriate for consolidaton.

Based on the applied business rules, a determination is made whether the account is eligible for consolidation of multiple account statements (step 107). In one embodiment, if the account is not eligible for consolidation, then a determination is made as to whether the account is eligible for householding of statements (step 108). In this embodiment, it is assumed that consolidation is preferred over householding from the senders perspective. However, this assumption could be overridden by customer preferences.

If the account is eligible for consolidation, then customer preference data 36 is checked for authorization to consolidate. If authorization is received (step 111), then customer and account data for all qualifying accounts are applied as a unit to the document template generated from document composition 34 (step 113). By consolidating, the sender may achieve significant savings. The document footprint is reduced resulting in reduced production costs and reduced defects. With fewer mailpieces USPS postage costs are reduced. Finally, consolidation can be tailored to maximize customer satisfaction.

At step 116, the appropriate one-to-one marketing messages are applied to the documents. For consolidated statements, the message need only be applied once. With all of the document content determined, the document printing and production data is generated (step 117). For future processing, a document identification number is established for each mail piece. The generated document object is then forwarded to the distributor engine 12.

Returning to the householding alternative at step 108, if the statements are not eligible for householding, then the document generation step 117 is carried out. If householding is available, customer preference data is checked for authorization to household. If authorization is not found (step 112), then customer and account data for each customer and account is applied separately to the document template to generate separate mail pieces (step 114). In a futher embodiment, when householding or consolidation is not authorized by the customer, then the sender may include a targeted message explaining the benefits of housholding and consolidation (step 119). If householding is available, the separate account data is marked as belonging to the same mail piece (step 115).

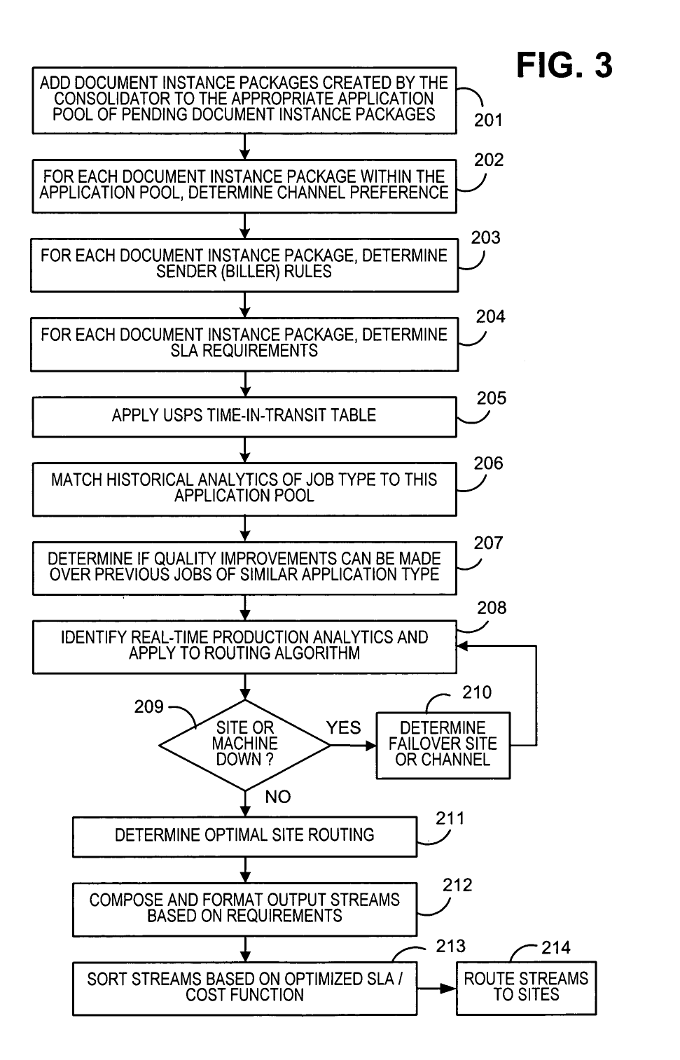

Once a mail piece is defined in accordance with the consolidator engine 11, the distributor enging 12 determines the manner of producing and delivering the document. FIG. 3 depicts exemplary steps carried out by the distributor engine 12 for achieiving efficiency and delivery goals.

In step 201, document packages created by the consolidator are added to a pool of pending packages for production and distribution. For each document package in the pool, the distributor 12 determines a preferred distribution channel. Customer preferences 36 identify whether they would like to receive communications electronically (via digital message delivery 6), or by mail (typically via an ADF 4). For each document instance package, the consolidator determines sender's rules 51 and SLA and quality requirments 55 (steps 203 and 204).

Often, minimizing delivery time is an objective for mail communications. Accordingly, in selecting the method of document production, at step 205 the distributor 12 applies USPS time-in-transit tables to determine delivery times to the recipient from various production sites. As such, distributor 12 will use USPS data to determine delivery time from each of the separate local sites 43, 44, and 45.

In a further embodiment, distributor 12 considers historical data for similar job types and applications (step 206). The historical data may include data on processing times, production costs, equipment failures, and frequency of errors in mail production. Depending on the applicable business rules, and goals for a particular instance of packages, different portions of this data may be of interest. A further step 207 carried out by the distributor is to determine if quality improvements can be made in a current mail run job over previous jobs of similar application type. Consolidator 12 also gathers the real time status and machine performance analytics from the local sites 43-45 (step 208). This real time information supplements the historical information gathered previously. If a site or machine is not operational (step 209), then an alternative site or distribution channel is identified (step 210).

Based on the input of information through steps 201-210, an optimal site routing is determined (step 211). The various rules and requirements determine the goals, and the statistics and analytics help determine how to best achieve thos goals. For example, if minimizing delivery time were a goal, then a site routing with the quickest processing time and delivery time would be selected. If minimizing costs took priority, then the site with the minimum costs could be selected. Similarly, for sensitive documentation, a site with a higher quality record could receive priority for processing a particular job. Preferrably, algorithms are applied in order to maximize value to the sender in view of all of the competing contraints and priorities. Where digital message delivery 6 is desired or permitted, it too will considered as one of the options for delivery of the communication.

When optimal routing is determined, the data streams are composed and formatted accordingly (step 212). The formatted streams are further sorted to meet contractual requirements or to optimize costs (step 213). The formatted and sorted streams are then routed to the sites 43-45, or 6, for production and delivery (step 214). After the distributor engine has completed routing of data streams, the global historical reporting system 7 is updated with the new information.

Thus, although the invention has been described with respect to a preferred embodiment thereof, it will be understood by those skilled in the art that the foregoing and various other changes, omissions and deviations in the form and detail thereof may be made without departing from the scope of this invention, as further described in the following claims.

1. A message processing system for preparing a plurality of messages to be distributed to customers, the system comprising:
a consolidator module receiving data corresponding to the plurality of messages, the consolidator module programmed to consolidate multiple of the plurality of messages into a single message package, the consolidator module consolidating the messages based on first criteria; and
a customer relationship management system coupled to the consolidator module, the customer relationship management system determining at least some of the first criteria.

2. The message processing system of claim 1 wherein the customer relationship management system determines a template for message packages and the template is transmitted to the consolidator module for forming the message packages.

3. The message processing system of claim 2 wherein the template includes marketing content developed by marketing tools in the customer relationship management system.

4. The message processing system of claim 1 wherein the first criteria include marketing business rules determined by the customer relationship management system.

5. The message processing system of claim 4 wherein the marketing rules include a rule that messages that include particular marketing content may, or may not, be consolidated.

6. The message processing system of claim 1 wherein the first criteria include customer preferences.

7. The message processing system of claim 6 wherein the first criteria includes a customer preference on whether or not consolidation is desired.

8. The message processing system of claim 6 wherein the first criteria includes a customer preference on whether or not householding is desired.

9. The message processing system of claim 1 wherein the consolidator module is coupled to a statement applications processing module, the statement applications processing module determining at least some of the first criteria.

10. The message processing system of claim 9 wherein the statement applications processing module provides message business data to the consolidator module for forming the message packages.

11. The message processing system of claim 9 wherein the statement applications processing module receives data from an automated data factory having a plurality of mail production sites.

12. The message processing system of claim 9 wherein the first criteria include sender rules received from the statement applications processing module.

13. The message processing system of claim 12 wherein the first criteria include a sender rule that messages that include particular business content may, or may not, be consolidated.

14. The message processing system of claim 12 wherein the first criteria include a sender rule that messages that include particular business content may, or may not, be householded.

15. The message processing system of claim 12 wherein the sender rules include a requirement to maximize throughput of message packages, and whereby the consolidator module forms message packages in order to maximize throughput.

16. The message processing system of claim 12 wherein the sender rules include a requirement to minimize mail production costs, and whereby the consolidator module forms message packages in order to minimize mail production costs.

17. The message processing system of claim 1 wherein the consolidator selects messages for consolidation from the plurality of messages based on the messages including a same delivery address.

18. The message processing system of claim 17 wherein the consolidator selects messages for consolidation based on messages having due dates proximal in time.

19. The message processing system of claim 18 wherein due dates of messages selected for consolidation are adjusted by the consolidator module to match.

20. The message processing system of claim 18 wherein the consolidator module determines whether a customer preference authorizes consolidation for a particular message, and whereby consolidation is disallowed by the consolidator module if there is no authorization.

21. The message processing system of claim 20 wherein, if the customer preference does not authorize consolidation, the consolidator generates content to be included in the message that describes benefits of consolidation.

22. The message processing system of claim 18 wherein the consolidator module determines whether a customer preference authorizes householding for a particular message, and whereby householding is disallowed by the consolidator module if there is no authorization.

23. The message processing system of claim 22 wherein, if the customer preference does not authorize householding, the consolidator generates content to be included in the message that describes benefits of householding.

24. A message processing system for preparing a plurality of messages to be distributed to customers, the system comprising:
a consolidator module receiving data corresponding to the plurality of messages, the consolidator module programmed to consolidate multiple of the plurality of messages into a single message package, the consolidator module consolidating the messages based on first criteria, wherein the consolidator module selects messages for consolidation from the plurality of messages based on the messages including a same delivery address and having due dates proximal in time.

25. The message processing system of claim 24 wherein due dates of messages selected for consolidation are adjusted by the consolidator module to match.

26. The message processing system of claim 24 wherein the consolidator module determines whether a customer preference authorizes consolidation for a particular message, and whereby consolidation is disallowed by the consolidator module if there is no authorization.

27. The message processing system of claim 26 wherein, if the customer preference does not authorize consolidation, the consolidator generates content to be included in the message that describes benefits of consolidation.

28. The message processing system of claim 24 wherein the consolidator module determines whether a customer preference authorizes householding for a particular message, and whereby householding is disallowed by the consolidator module if there is no authorization.

29. The message processing system of claim 28 wherein, if the customer preference does not authorize householding, the consolidator generates content to be included in the message that describes benefits of householding.

30. A method for processing and preparing a plurality of messages to be distributed to recipients, the method comprising:
receiving data corresponding to the plurality of messages;
consolidating multiple of the plurality of messages into single message packages, said consolidating of the messages into consolidated message packages based on first criteria; and
determining at least some of the first criteria through a customer relationship management system.

31. The method of claim 30 further comprising the step of determining a template for message packages with the customer relationship management system.

32. The method of claim 31 wherein the step of determining the template comprises including marketing content developed by marketing tools in the customer relationship management system.

33. The method of claim 30 wherein the step of determining the first criteria includes marketing business rules determined by the customer relationship management system.

34. The method of claim 33 including a step of preventing messages from being consolidated based on the marketing rules that include a rule that messages that include particular marketing content may, or may not, be consolidated.

35. The method of claim 30 further including gathering customer preference data and including it in the first criteria.

36. The method of claim 35 wherein the step of consolidating is controlled based on the first criteria which includes a customer preference on whether or not consolidation is desired.

37. The method of claim 35 wherein the step of consolidating is controlled based on the first criteria which includes a customer preference on whether or not householding is desired.

38. The method of claim 30 further including the step of determining at least some of the first criteria with a statement applications processing module.

39. The method of claim 38 further including the step of providing message business data from the statement applications processing module for forming the message packages.

40. The method of claim 38 wherein the step of determining at least some of the first criteria includes incorporating sender rules received from the statement applications processing module.

41. The method of claim 40 wherein the step of consolidating is controlled by the first criteria which includes a sender rule that messages that include particular business content may, or may not, be consolidated.

42. The method of claim 40 wherein the step of consolidating is controlled by the first criteria which includes a sender rule that messages that include particular business content may, or may not, be householded.

43. The method of claim 40 wherein the sender rules include a requirement to maximize throughput of message packages, and the step of consolidating is controlled to form message packages in order to maximize throughput.

44. The method of claim 40 wherein the sender rules include a requirement to minimize mail production costs, and wherein the step of consolidating is controlled to form message packages in order to minimize mail production costs.

45. The method of claim 30 wherein the step of consolidating includes selecting messages for consolidation from the plurality of messages based on the messages having a same delivery address.

46. The method of claim 45 wherein the step of consolidating includes selecting messages for consolidation based on messages having due dates proximal in time.

47. The method of claim 46 wherein the step of consolidating includes adjusting the due dates of messages selected for consolidation so that consolidated messages have the same due dates.

48. The method of claim 46 wherein the step of consolidating includes determining whether a customer preference authorizes consolidating for a particular message, and whereby consolidating is disallowed if there is no authorization.

49. The method of claim 48 wherein, if the customer preference does not authorize consolidation, further including a step of generating content to be included in the message describing benefits of consolidation.

50. The method of claim 46 wherein the step of consolidating includes determining whether a customer preference authorizes householding for a particular message, and whereby householding is disallowed if there is no authorization.

51. The method of claim 50 wherein, if the customer preference does not authorize householding, further including a step of generating content to be included in the message describing benefits of householding.

52. A method for processing and preparing a plurality of messages to be distributed to recipients, the method comprising:
receiving data corresponding to the plurality of messages; consolidating multiple of the plurality of messages into single message packages, said consolidating of the messages into consolidated message packages based on first criteria, wherein the step of consolidating includes selecting messages for consolidation from the plurality of messages based on the messages having a same delivery address and having due dates proximal in time.

53. The method of claim 52 wherein the step of consolidating includes adjusting the due dates of messages selected for consolidation so that consolidated messages have the same due dates.

54. The method of claim 52 wherein the step of consolidating includes determining whether a customer preference authorizes consolidating for a particular message, and whereby consolidating is disallowed if there is no authorization.

55. The method of claim 54 wherein, if the customer preference does not authorize consolidation, further including a step of generating content to be included in the message describing benefits of consolidation.

56. The method of claim 52 wherein the step of consolidating includes determining whether a customer preference authorizes householding for a particular message, and whereby householding is disallowed if there is no authorization.

57. The method of claim 56 wherein, if the customer preference does not authorize householding, further including a step of generating content to be included in the message describing benefits of householding.
